(19) United States
(12) Patent Application Publication
(10) Pub. No.: US 2026/0256166 A1
(43) Pub. Date: Sep. 3, 2026

(54) PLANT-BASED GROUND AND FORMED MEAT ALTERNATIVES

(71) Applicant: Cargill, Incorporated, Wayzata, MN (US)

(72) Inventors: Fang LIE, Edegem (BE); Zuzana VAN BEVEREN, Hombeek (BE); Pablo ZATARAIN HERNANDEZ, Gembloux (BE)

(21) Appl. No.: 18/875,243

(22) PCT Filed: Jun. 22, 2023
(86) PCT No.: PCT/US2023/068874

§ 371 Date: Dec. 16, 2024

(30) Foreign Application Priority Data
Jun. 24, 2022 (EP) 22181124.3

(51) Int. Cl. A23J 3/18; A23J 3/22; A23L 29/212; A23L 29/256; A23L 29/262

(52) U.S. Cl. CPC A23J 3/18; A23J 3/227; A23L 29/212; A23L 29/256; A23L 29/262

(57) ABSTRACT

The present disclosure relates to a meat substitute composition that comprises a textured plant protein, a plant protein powder, and a binding system. The present disclosure also relates to a meat substitute product that comprises the meat substitute composition. A method of making a meat substitute product is also described herein.

### CROSS-REFERENCE TO RELATED APPLICATIONS

This application claims the benefit of European Application No. 22181124.3, filed Jun. 24, 2022, which is hereby incorporated by reference in its entirety.

### BACKGROUND

Traditionally, meat products have taken an important place in our diet. Meat products are consumed in many different forms as whole muscle or minced pieces of meat that are cooked, grilled, smoked, cured, or fermented in form of hamburgers, patties, sausages, meat balls, nuggets and many more.

There is a growing consumer trend for reducing or completely removing animal protein from their diets. Consumers switch towards plant-based meat substitutes because of various reasons such as health concerns, environmental concerns, sustainability, or animal welfare.

In order for a regular meat consumer to be motivated to choose for meat substitutes, it is critical that these substitutes mimic processed meat products in terms of texture and organoleptic properties, like appearance, flavor, bite, succulence, mouthfeel, and overall acceptance.

There is still a need to improve the texture and/or organoleptic properties of meat substitutes. The present invention provides such a solution.

### SUMMARY

The present disclosure provides a meat substitute composition that comprises a textured plant protein comprising a pea protein and a wheat gluten, a plant protein powder, and a binding system. Textured pea protein and wheat gluten in the textured plant protein is in a ratio of 1:0.5 to 1:1.5.

The present disclosure also provides a meat substitute product that comprises a meat substitute composition.

The present disclosure further provides a use of a meat substitute composition to make a meat substitute product.

The present disclosure also provides a method of making a meat substitute product that comprises steps of providing a textured plant protein, a plant protein powder, and a binding system; dispersing one or more coloring agent, one or more flavoring agent, and one or more shelf life extender in water to form a hydrate; mixing the hydrate with the textured plant protein and the plant protein powder to form a mixture; mixing the mixture with the binding system and one or more of the following: fat(s) and/or oil(s), salt, water, and optionally a coloring agent, a flavoring agent, and/or a shelf life extender to obtain a meat substitute product dough; and cooling and shaping the meat substitute product dough to form the meat substitute product.

The present invention is as set out in the following clauses:
1. A meat substitute composition, comprising:
   a. a textured plant protein that comprises
      i. pea protein; and
      ii. wheat gluten;
   b. a plant protein powder; and
   c. a binding system;
   wherein pea protein and wheat gluten in the textured combination is in a ratio 1:0.5 to 1:1.5.
2. The meat substitute composition of clause 1, wherein the plant protein powder comprises:
   a. a pea protein; and
   b. a wheat gluten;
   wherein the pea protein and the gluten are in a ratio of 1:0.4 to 1:1.
3. The meat substitute composition of any of the preceding clauses, wherein the binding system comprises:
   a. a carrageenan;
   b. a starch;
   c. a plant-based fiber; and
   d. a methylcellulose.
4. The meat substitute composition of any of the preceding clauses, wherein the binding system comprises, based on a total weight of the binding system:
   a. 15 to 45 wt % carrageenan;
   b. 10 to 40 wt % starch;
   c. 1 to 10 wt % plant-based fiber; and
   d. 25 to 55 wt % methylcellulose.
5. The meat substitute composition of any of the preceding clauses, comprising from 10 to 30 wt % of the textured plant protein and wheat gluten based on a total weight of the meat substitute composition.
6. The meat substitute composition of any of the preceding clauses, comprising from 3 to 15 wt % of the plant protein powder based on a total weight of the meat substitute composition.
7. The meat substitute composition of any of the preceding clauses, comprising from 2 to 8 wt % of the binding system based on a total weight of the meat substitute composition.
8. The meat substitute composition of any of the preceding clauses, comprising one or more of the following:
   a. fat(s) and/or oil(s);
   b. salt;
   c. water; and
   d. optionally a coloring agent, a flavoring agent, and/or a shelf life extender.
9. The meat substitute composition of any of the preceding clauses, comprising, based on a total weight of the meat substitute composition:
   a. 10 to 30 wt % textured plant protein;
   b. 1 to 15 wt % plant protein powder;
   c. 2 to 8 wt % binding system;
   d. 5 to 20 wt % fat(s) and/or oil(s);
   e. 0.1 to 1.5 wt % salt;
   f. 40 to 70 wt % water;
   g. 0.01 to 5 wt % coloring agent;
   h. 0.01 to 5 wt % flavoring agent; and
   i. 0.01 to 10 wt % shelf life extender.
10. A meat substitute product comprising the meat substitute composition of any of the preceding clauses.
11. The meat substitute product of clause 10, wherein the meat substitute product is selected from a group consisting of vegetarian or vegan alternatives of burgers, meatballs, minced meat, sausages, nuggets, crumbles, seafood, poultry, breakfast meat, and pet food.
12. Use of a meat substitute composition of any one of clauses of 1 to 9 to make a meat substitute product.
13. A method of making a meat substitute product, comprising the steps of:
   a. dispersing one or more of the following in water to form a hydrate:
      i. one or more coloring agent(s);
      ii. one or more flavoring agent(s); and
      iii. one or more shelf life extender(s);
      or providing water
   b. mixing the hydrate (or water) from step (a) with a textured plant protein and a plant protein powder to form a mixture;
   c. mixing the mixture from step (b) with a binding system and one or more of the following to obtain the meat substitute product dough:
      i. fat(s) and/or oil(s);
      ii. salt;
      iii. water; and
      iv. optionally any (additional) coloring agent, flavoring agent, and/or shelf life extender; and
   d. cooling and shaping the meat substitute product dough to form the meat substitute product.
14. The method of clause 13, wherein pea protein and wheat gluten in the textured plant protein is in a ratio 1:0.5 to 1:1.5.
15. The method of any of clauses 13 and 14, wherein the meat substitute product comprises the meat substitute composition of any one of clauses 1 to 9.
16. A meat extender food product comprising the meat substitute composition according to any one of clauses 1 to 9 and meat-derived ingredients.
17. Use of the meat substitute composition according to any one of clauses 1 to 9 in a meat extender food product further comprising meat-derived ingredients.

### DETAILED DESCRIPTION

Reference will now be made in detail to certain aspects of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Unless defined otherwise, all technical and scientific terms used herein have the same meaning as commonly understood by one skilled in the art to which this invention belongs. As used herein, each of the following terms has the meaning associated with it as defined below.

Unless expressly stated, ppm (parts per million), percentage, and ratios are on a by weight basis. Percentage on a by weight basis is also referred to as wt % below.

The term “for example,” “for instance,” “such as,” or “including” as used herein is meant to introduce examples that further clarify more general subject matter. Unless otherwise specified, these examples are provided only as an aid for understanding the applications illustrated in the present disclosure and are not meant to be limiting in any fashion.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used herein, “room temperature” or “RT” refer to a temperature between 20° C. and 25° C.

### Meat Substitute Composition

The present disclosure relates to a meat substitute composition that comprises a textured plant protein comprising a pea protein and a wheat gluten, a plant protein powder, and a binding system. The composition is designed for making a meat substitute product.

### Textured Plant Protein

Plant protein is one of the main building blocks for a meat substitute composition. In one aspect, textured plant protein and non-texturized plant protein (e.g., plant protein powder) are two major sources of plant protein in a meat substitute composition. Textured plant protein provides, inter alia, meat-like texture (e.g., bite and chewiness) and water holding properties to a meat substitute composition.

In the meat substitute composition of the present disclosure, a textured plant protein that comprises (or essentially consists of) a pea protein and a wheat gluten is used. Pea protein and wheat gluten are texturized together to form the textured plant protein. The texturized pea protein and wheat gluten can be prepared by dry extruding a composition comprising pea protein and wheat gluten. Dry extrusion is also referred to as low-moisture extrusion. Dry extrusion can be carried out for instance in a twin-screw extruder. Typically, in a dry extrusion process, the moisture content of the composition being extruded is at most 30 wt %, for instance from 8 to 30 wt %, or from 10 to 30 wt %, or from 15 to 25 wt %, or from 15 to 22 wt % based on the total weight of the composition. Processing aids may be used in the extrusion process, for instance, known pH buffering systems like caustic, vinegar or other edible acids.

The pea protein in the textured plant protein is a pea protein isolate. The protein content of the pea protein isolate can, preferably, be in a range of 75 to 90 wt %, 75 to 85 wt %, 80 to 85 wt %, or 80 to 90 wt % on a dry basis. The pea protein can be, for example, Radipure™ S from Cargill.

The wheat gluten the textured plant protein is also known as vital wheat gluten or wheat protein. The protein content of the wheat gluten can, preferably, be in a range of 70 to 85 wt %, 70 to 80 wt %, 75 to 85 wt %, or 75 to 80 wt % on a dry basis. The wheat gluten can be, for example, Gluvital™ 21020 from Cargill.

The weight ratio of pea protein and wheat gluten present in the textured plant protein can, preferably, be in a range of 1:0.5 to 1:1.5, 1:0.6 to 1:1.4, 1:0.7 to 1:1.3, 1:0.8 to 1:1.2, 1:0.9 to 1:1.1, 1:0.5 to 1:1, 1:0.8 to 1:1, 1:1 to 1:1.3, or 1:1 to 1:1.5. In one aspect, pea protein and wheat gluten are present in the textured plant protein in a weight ratio of at least 1:0.5, or at most 1:1.5. Preferably, the pea protein and wheat gluten are present in a weight ratio of 1:0.5 to 1:1.5, most preferably at a 1:1.

The meat substitute composition can, preferably, include 10 to 30 wt %, 15 to 25 wt %, 10 to 18 wt %, 15 to 18 wt %, 18 to 20 wt %, 18 to 22 wt %, 18 to 25 wt %, 18 to 30 wt %, 10 to 20 wt %, 15 to 20 wt %, 20 to 22 wt %, 20 to 25 wt %, or 20 to 30 wt % textured plant protein based on the total weight of the meat substitute composition. In one aspect, the textured plant protein present in the meat substitute composition is in an amount of 10 wt %, 15 wt %, 18 wt %, 20 wt %, 22 wt %, 25 wt %, or 30 wt % based on the total weight of the meat substitute composition.

### Plant Protein Powder

Plant protein powder can be selected from any known plant proteins in a powder form, i.e., non-texturized. The plant protein can be selected from legume protein (e.g., pea, fava, soy, chickpea, lupin, mung bean, and lentil protein), cereal protein (e.g., corn, wheat, oat, barley, rice protein), pseudocereal protein (e.g., buckwheat, amaranth, quinoa), potato protein, water lentil protein, canola protein, sunflower protein, hemp protein and pumpkin protein. Such plant protein powder can contribute to functional (e.g., firmness, elasticity, cohesiveness, and water binding) and nutritional aspects for a meat substitute composition.

In one aspect, the plant protein powder in the meat substitute composition of the present disclosure comprises (or essentially consists of) a pea protein isolate and a wheat gluten.

The weight ratio of pea protein isolate and wheat gluten present in the plant protein powder can, preferably, be in a range of 1:0.4 to 1:1, 1:0.5 to 1:0.9, or 1:0.6 to 1:0.8. In one aspect, pea protein isolate and wheat gluten are present in the plant protein powder in a weight ratio of at least 1:0.4, or at most 1:1. Preferably, the pea protein isolate and wheat gluten are present in a weight ratio of 1:0.4 to 1:1, most preferably at a 1:0.7.

The meat substitute composition can, preferably, include 3 to 15 wt %, 5 to 12 wt %, or 7 to 10 wt plant protein powder based on the total weight of the meat substitute composition. In one aspect, the plant protein powder present in the meat substitute composition is in an amount of 3 wt %, 5 wt %, 7 wt %, 9 wt %, 10 wt %, 12 wt %, or 15 wt % based on the total weight of the meat substitute composition.

The protein content of the pea protein isolate can, preferably, be in a range of 75 to 90 wt %, 75 to 85 wt %, 80 to 85 wt %, or 80 to 90 wt % on a dry basis. The pea protein can be, for example, Radipure™ S from Cargill.

Wheat gluten in the plant protein powder is also known as vital wheat gluten or wheat protein. The protein content of the wheat gluten can, preferably, be in a range of 70 to 85 wt %, 70 to 80 wt %, 75 to 85 wt %, or 75 to 80 wt % on a dry basis. The wheat gluten can be, for example, Gluvital™ 21020 from Cargill.

### Binding System

A binding system provides properties such as firmness, water binding, fat binding, and cohesiveness to a meat substitute composition.

In one aspect, binding system in the meat substitute composition of the present disclosure comprises a carrageenan, a starch, a plant-based fiber, and a methylcellulose. In one aspect, the above components of carrageenan, starch, plant-based fiber, and methylcellulose are pre-blended to form the binding system.

The meat substitute composition can, preferably, include 2 to 8 wt %, 2 to 4 wt %, 4 to 6 wt %, or 4 to 8 wt % binding system based on the total weight of the meat substitute composition. In one aspect, the binding system present in the meat substitute composition is in an amount of 2 wt %, 4 wt %, 5 wt %, 6 wt %, or 8 wt % based on the total weight of the meat substitute composition.

In one aspect, the binding system comprises a pre-blended mixture of:
(a) a carrageenan in an amount of 0.85 to 1.4 wt %, 0.95 to 1.3 wt %, 1 to 1.2 wt %, 0.85 to 1.15 wt %, 1.15 to 1.4 wt % based on the total weight of the meat substitute composition;
(b) a starch in an amount of 0.25 to 2.25 wt %, 0.5 to 2 wt %, 0.75 to 1.75 wt %, 1 to 1.5 wt %, 0.25 to 1 wt %, or 1 to 2.25 wt % based on the total weight of the meat substitute composition;
(c) a plant-based fiber in an amount of 0.1 to 1 wt %, 0.2 to 0.8 wt %, 0.1 to 0.25 wt %, 0.25 to 1 wt %, 0.3 to 0.7 wt %, 0.1 to 0.5 wt %, or 0.5 to 1 wt % based on the total weight of the meat substitute composition; and
(d) a methylcellulose in an amount of 1 to 2 wt %, 1.1 to 1.9 wt %, 1.2 to 1.8 wt %, 1.3 to 1.7 wt %, 1.4 to 1.6 wt %, 1 to 1.5 wt %, or 1.5 to 2 wt % based on the total weight of the meat substitute composition.

In one aspect, carrageenan present in the binding system can be in a range of 15 to 45 wt %, 20 to 40 wt %, 25 to 35 wt %, 15 to 30 wt %, or 30 to 45 wt % based on the total weight of the binding system. Starch present in the binding system can be in a range of 10 to 40 wt %, 15 to 35 wt %, 20 to 30 wt %, 10 to 25 wt %, or 25 to 40 wt % based on the total weight of the binding system. Plant-based fiber present in the binding system can be in a range of 1 to 10 wt %, 3 to 8 wt %, 1 to 5 wt %, or 5 to 10 wt % based on the total weight of the binding system. Methylcellulose present in the binding system can be in a range of 25 to 55 wt %, 30 to 50 wt %, 35 to 45 wt %, 25 to 40 wt %, or 40 to 55 wt % based on the total weight of the binding system.

Carrageenan is an example of hydrocolloids that are polysaccharides of high molecular weight, extracted from plants or seaweeds and form colloidal systems when dispersed in water. Other examples of hydrocolloids that can be present in the binding system include, but are not limited to, starches, xanthan gum, guar gum, locust bean gum, konjac gum, cellulose derivatives, alginate, pectin, gellan gum, agar, plant-based fibers, or combinations of two or more thereof. Carrageenan or any example of hydrocolloids may be added to the meat substitute composition for their water binding capacity and gelling capacity. This may influence juiciness and mouthfeel as well as firmness and product stability during shelf life.

Starch may be from various botanical sources that include, but are not limited to, potato starch, tapioca starch, rice starch, pea starch, waxy corn starch, wheat starch, or maize starch. They may be in form of native starch, physically or chemically modified starch, or combinations of two or more thereof.

Plant-based fiber can be any naturally derived fibers. Examples of plant-based fiber that can be present in the binding system include, but are not limited to, citrus fibers, legume fibers (e.g., pea fibers), flax fibers, potato fibers, psyllium fibers, bamboo fibers, apple fibers, carrot fibers, tapioca fibers, plantain fibers, cane sugar fibers, cereal fibers (e.g., millet fibers, oat fibers, barley fibers, corn fibers, wheat fibers), or combinations of two or more thereof.

Methylcellulose is an example of cellulose derivatives. Other examples of cellulose derivatives that can be present in the binding system include, but are not limited to, carboxymethyl cellulose or hydroxypropyl methylcellulose.

### Other Ingredients

In one aspect, the meat substitute composition of the present disclosure comprises one or more fat(s) and/or oil(s) selected from a group consisting of rapeseed oil, coconut oil, coconut fat, cottonseed oil, corn oil, canola oil, palm fat, groundnut oil, linseed oil, olive oil, rice bran oil, sesame oil, safflower oil, soybean oil, sunflower oil, and mixture of two or more thereof. The meat substitute composition of the present disclosure comprises fat and/or oil in an amount of 5 wt %, 10 wt %, 15 wt %, or 20 wt % based on the total weight of the composition. The composition can, preferably, include 5 to 20 wt %, 5 to 15 wt %, 10 to 20 wt %, or 10 to 15 wt % fat(s) and/or oil(s) based on the total weight of the composition.

In one aspect, the meat substitute composition of the present disclosure comprises salt in an amount of 0.1 wt %, 0.3 wt %, 0.5 wt %, 0.8 wt %, 1 wt %, or 1.5 wt % based on the total weight of the composition. The composition can, preferably, include 0.1 to 1.5 wt %, 0.3 to 1 wt %, 0.1 to 0.5 wt %, 0.5 to 0.8 wt %, or 0.5 to 1.5 wt % salt based on the total weight of the composition. Salt can be any standard food-grade kitchen salts (e.g., sodium chloride).

In one aspect, the meat substitute composition of the present disclosure comprises water in a total amount of 40 wt %, 45 wt %, 50 wt %, 55 wt %, 60 wt %, 65 wt %, or 70 wt % based on the total weight of the composition. The composition can, preferably, include a total amount of 40 to 70 wt %, 45 to 65 wt %, 50 to 60 wt %, 40 to 55 wt %, or 55 to 70 wt % water based on the total weight of the meat substitute composition. The total amount of water can, preferably, refer to an amount of water that is used to hydrate the textured plant protein and disperse flavoring agents and coloring agents (hydration water), as well as an added amount of water that is used to disperse other ingredients of the meat substitute composition (additional water). In one aspect, a ratio of textured plant protein to hydration water is between 1:2, 1:2.5, 1:3, 1:3.5, 1:4, 1:4.5, or 1:5.

In one aspect, the meat substitute composition comprises one or more ingredients selected from coloring agents, flavoring agents, and shelf life extenders. The amount of each ingredient, if present, is in a range of 0.01 to 10 wt %, 0.01 to 8 wt %, 0.01 to 5 wt %, 0.01 to 3 wt %, 0.01 to 1 wt %, 0.01 to 0.9 wt %, 0.01 to 0.3 wt %, 0.1 to 10 wt %, 0.1 to 8 wt %, 0.1 to 3 wt %, 0.1 to 1 wt %, or 0.1 to 0.9 wt % based on the total weight of the meat substitute composition.

Shelf life extenders may include, but are not limited to, herbs (e.g., oregano, basil, rosemary, sage, savory, thyme, bay leave), spices (e.g., pepper, white pepper, black pepper, mustard, cloves, nutmeg, turmeric, ginger, chili pepper), vinegar, dried vegetables (e.g., shallots, garlic, onion), or combinations of two or more thereof.

### Meat Substitute Product

The meat substitute composition of the present disclosure is designed for making a meat substitute product.

Meat substitute products are food or feed compositions that mimic animal processed whole-muscle meat products as well as processed restructured meat products such as burgers, patties, sausages, meatballs, and the like. Methods of processing for processed meat products may be chopping, fermentation, boiling, smoking, extrusion, or other processes.

Meat substitute products can be divided into ground, also called minced, products and fine paste products. Ground meat substitute products are coarse-particle products such as alternatives for burgers, patties, sausages, meatballs, nuggets, and the like. Fine paste products are typically emulsified products such as alternatives for frankfurter, bologna, mortadella, and the like.

In one aspect, the meat substitute product is a ground meat substitute. The ground meat substitute product may be shaped in a form, such as the form of a burger, a patty, a meatball, a nugget, or a sausage.

In another aspect, the ground meat substitute product is a ground vegetarian protein product. The ground vegetarian protein product is not based on meat or fish. More preferably, the ground meat substitute product is a ground vegan protein product. The ground vegan protein product is not based on products derived from animals. Examples of products derived from animals may include, but are not limited to, meat, fish, eggs, milk, or honey.

The meat substitute product of the present invention is typically designed for consumption after cooking.

Alternatively, the meat substitute product of the present invention is a pet food. The term “pet food” means any food composition intended to be consumed by a pet. A pet may be any domestic or tamed animal kept for companionship or pleasure. The pet can, preferably, be an avian, bovine, canine, equine, feline, hircine, lupine, murine, ovine, or porcine animal. Preferably, the pet is a dog or a cat.

In one aspect, the meat substitute composition of the present disclosure can be used in making a plant-based burger. Table 1 provides a preferred composition of such a meat substitute composition.

TABLE 1

| | Amount based on total |
|---|---|
| | weight of composition |
| Ingredient | (wt %) |
| Textured plant protein | 10-30 |
| Plant protein powder | 3-15 |
| Binding system | 2-8 |
| Fat(s) and/or oil(s) | 5-20 |
| Salt | 0.1-1.5 |
| Water | 40-70 |
| Coloring agent | 0.01-3 |
| Flavoring agent | 0.01-5 |
| Shelf life extender | 0.01-10 |

In another aspect, the meat substitute composition of the present disclosure can be used in making a plant-based meatball or a plant-based minced meat. Preferably, additional flavoring agents and/or shelf life extenders can be added to such meat substitute composition in making a plant-based meatball or a plant-based minced meat. Table 2 provides a preferred composition of such a meat substitute composition.

TABLE 2

| | Amount based on total |
|---|---|
| | weight of composition |
| Ingredient | (wt %) |
| Textured plant protein | 10-30 |
| Plant protein powder | 3-15 |
| Binding system | 2-8 |
| Fat(s) and/or oil(s) | 5-20 |
| Salt | 0.1-1.5 |
| Water | 40-70 |
| Coloring agent | 0.01-3 |
| Flavoring agent | 0.01-5 |
| Shelf life extender | 0.01-5 |

### Method of Making a Meat Substitute Product

In accordance with the present disclosure, a method of making a meat substitute product comprises the steps of: (a) dispersing one or more of the following: one or more coloring agent(s), one or more flavoring agent(s), and one or more shelf life extender(s) in water to form a hydrate; (b) mixing the hydrate from step (a) with a textured plant protein and a plant protein powder to form a mixture; (c) mixing the mixture from step (b) with a binding system and one or more of the following to obtain a meat substitute product dough: fat(s) and/or oil(s), salt, water, and optionally any additional coloring agent, flavoring agent, and/or shelf life extender; and (d) cooling and shaping the meat substitute product dough to form the meat substitute product. The cooled dough can, preferably, be shaped in a form of a burger or a meatball.

In one aspect, the cooled dough can be further grinded through a meat grinder to form a minced meat like structure. In another aspect, a flavoring agent and/or a shell life extender can be additionally included in making a plant-based meatball or a plant-based minced meat.

In one aspect, different from conventional processes for making a meat substitute product, a methylcellulose emulsion is not needed to be prepared separately for hydrocolloid functionality activation.

It is also possible not to use any coloring agent(s), flavoring agent(s), or shelf life extender(s) in step (a). In this case, step (a) is providing water and step (b) is mixing the water with a textured plant protein and a plant protein powder to form a mixture. It is possible to add coloring agent(s), flavoring agent(s), and/or shelf life extender(s) only in step (c).

Also disclosed herein are (a) A meat extender food product comprising the meat substitute product and meat derived ingredients, and (b) Use of the meat substitute product in a meat extender food product further comprising meat derived ingredients.

### EXAMPLES

The invention is further described in detail by reference to the following experimental examples. These examples are provided for purposes of illustration only and are not intended to be limiting unless otherwise specified. Thus, the invention should in no way be construed as being limited to the following examples, but rather should be construed to encompass any and all variations which become evident as a result of the teaching provided herein.

### Example 1—Recipe of the Meat Substitute Product

Recipes for making different types of meat substitute products are shown in Table 3, in which concentrations of the ingredients were measured in wt % of the total weight of the recipe. For example, recipes A and B are suitable for making plant-based burger, and recipe C is suitable for making plant-based meatball or plant-based minced meat.

TABLE 3

| Ingredient | Recipe A | Recipe B | Recipe C |
|---|---|---|---|
| Water | 54.60 | 55.24 | 59.20 |
| Cargill ™ Plant Protein Tex PW80 | 18.00 | 18.00 | 20.00 |
| M (Cargill) | | | |
| Kitchen salt | 0.50 | 0.50 | 0.50 |
| Plant protein powder | 9.00 | 5.00 | 5.00 |
| (Trilisse MVP 1201, Cargill) | | | |
| Binding system | 3.90 | 4.40 | — |
| (Flanogen REM 2460 Cargill) | | | |
| Binding system | — | — | 4.50 |
| (Flanogen REM 2360 Cargill) | | | |

Coloring agent

| | | | |
|---|---|---|---|
| VegeBrite Malt Powder PWS | 0.30 | 0.30 | — |
| (Naturex) | | | |
| VegeBrite Beetroot PWS (Naturex) | 0.60 | 0.60 | 0.50 |
| VegeBrite Juicy Brown Pear PWS | — | — | 0.30 |
| (Naturex) | | | |
| Malt extract powder MEP-P50 | 2.00 | 2.00 | — |
| (Diastatische Producten) | | | |
| Grilled meat flavoring agent | 3.20 | 2.56 | — |
| (for instance, from Givaudan) | | | |

Fat(s) and/or oil(s)

| | | | |
|---|---|---|---|
| Rapeseed oil (Vandemoortele) | 4.50 | 8.00 | 6.0 |
| Fully Refined Coconut Oil (Cargill) | 6.00 | 6.00 | 4.0 |

Shelf life extender

| | | | |
|---|---|---|---|
| Frozen shallots | 4.00 | 4.00 | — |
| Garlic | 0.80 | 0.80 | — |
| White pepper | 0.20 | 0.20 | — |
| Vinegar | 1.00 | 1.00 | 2.00 |

“Trilisse MVP 1201” is the plant protein powder used in the recipes that includes pea protein isolate (Radipure™ S, Cargill) and wheat gluten (Gluvital™ 21020, Cargill). “Flanogen REM 2460 and REM 2360” are the binding systems used in the recipes that include carrageenan (Satiagel RMP 64 R2, Cargill), potato starch (Simpure 99500, Cargill), citrus fiber (CitriPure FA 1501, Cargill), and methylcellulose (Ashland). “Cargill™ Plant Protein Tex PW80 M” (Cargill) is a textured plant protein ingredient made by dry extrusion of a composition consisting of 50 wt % pea protein (Radipure™ S, Cargill) and 50 wt % wheat gluten (Gluvital™ 21020, Cargill).

### Example 2—Preparation of the Meat Substitute Product

The following steps were taken to prepare the meat substitute product of the present invention:
(1) Coloring agents, flavoring agents, and frozen shallots were dispersed in water to form a hydrate.
(2) Textured plant protein was mixed with the hydrate under vacuum for 10 minutes until the textured plant protein was homogenously well hydrated to form a hydrated textured plant protein.
(3) Plant protein powder was mixed with the hydrated textured plant protein for 3 minutes without vacuum to form a mixture.
(4) Vinegar was mixed with the mixture from step (3) for 2 minutes to reduce pH of the mixture and allow gluten (present in the textured plant protein and plant protein powder) to develop viscoelasticity.
(5) Binding system, salt, garlic, and white pepper were mixed with the mixture from step (4) for 4 minutes.
(6) Rest of the water was mixed with the mixture from step (5) for 3 minutes.
(7) Rapeseed oil and coconut fat were blended with the hydrated mixture from step (6) for 2 minutes. A meat substitute product dough was obtained.
(8) The meat substitute product was obtained by cooling the dough at 4° C. and shaping the cooled dough in a form of a burger or a meatball. The cooled dough can be further grinded through a meat grinder to form a minced meat like structure.

In making plant-based meatball and plant-based minced meat, ingredients such as flavoring agents and shell life extenders, in addition to the amounts listed in Table 3, can be included. Table 4 shows such recipes (recipes D and E) with the additional flavoring agents and shell life extenders for making plant-based meatball and plant-based minced meat, respectively. Concentrations of the ingredients were measured in wt % of the total weight of the recipe.

TABLE 4

| Ingredient | Recipe D | Recipe E |
|---|---|---|
| Meat substitute dough from Recipe C | 85.15 | 92.70 |
| Kitchen salt | 0.80 | 0.60 |
| Flavoring agents, combination of different | 1.0 | 1.05 |
| savory flavoring agents (for instance from | | |
| Givaudan) | | |

Shelf life extender

| | | |
|---|---|---|
| Frozen shallots | 10.00 | 4.40 |
| Frozen parsley | 0.90 | — |
| Garlic powder | 0.30 | 0.40 |
| Paprika powder soft | 0.30 | 0.50 |
| Dried oregano | 0.10 | — |
| White pepper | 0.15 | 0.15 |
| Nutmeg | 0.30 | 0.20 |
| Sugar | 1.00 | — |

### Example 3—Sensory Testing of Plant-Based Burger

A sensory evaluation was conducted to compare different recipes (Recipes A, B, F, and G) for making plant-based burgers. Table 5 shows the compositions of recipes F and G, where recipes A and B were reproduced in Table 5 for ease of comparison. Concentrations of the ingredients were measured in wt % of the total weight of the recipe.

TABLE 5

| Ingredient | Recipe A | Recipe B | Recipe F | Recipe G |
|---|---|---|---|---|
| Water | 54.60 | 55.24 | 55.50 | 54.84 |
| Cargill ™ Plant Protein | 18.00 | 18.00 | 18.00 | 18.00 |
| Tex PW80 M (Cargill) | | | | |
| Kitchen salt | 0.50 | 0.50 | 0.50 | 0.50 |
| Plant protein powder | 9.00 | 5.00 | 5.00 | 6.00 |
| (Trilisse MVP 1201, | | | | |
| Cargill) | | | | |
| Binding system | 3.90 | 4.40 | 4.40 | 4.40 |
| (Flanogen REM 2460, | | | | |
| Cargill) | | | | |

Coloring agent

| | | | | |
|---|---|---|---|---|
| VegeBrite Malt Powder | 0.30 | 0.30 | — | — |
| PWS (Naturex) | | | | |
| VegeBrite Beetroot PWS | 0.60 | 0.60 | — | — |
| (Naturex) | | | | |
| VegeBrite Caramelised | — | — | 0.25 | 0.25 |
| Sugar PWS (Naturex) | | | | |
| Beetroot Extract HC | — | — | 0.05 | 0.05 |
| PWS (Naturex) | | | | |
| Malt extract powder | 2.00 | 2.00 | 2.00 | 2.00 |
| MEP-P50 (Diastatische | | | | |
| Producten) | | | | |
| Grilled meat flavoring | 3.20 | 2.56 | 2.90 | 2.56 |
| agent (for instance from | | | | |
| Givaudan) | | | | |

Fat(s) and/or oil(s)

| | | | | |
|---|---|---|---|---|
| Rapeseed oil | 4.50 | 8.00 | 8.00 | 8.00 |
| (Vandemoortele) | | | | |
| Fully Refined Coconut | 6.00 | 6.00 | 6.00 | 6.00 |
| Oil (Cargill) | | | | |

Shelf life extender

| | | | | |
|---|---|---|---|---|
| Frozen shallots | 4.00 | 4.00 | 4.00 | 4.00 |
| Garlic | 0.80 | 0.80 | 0.80 | 0.80 |
| White pepper | 0.20 | 0.20 | 0.20 | 0.20 |
| Vinegar | 1.00 | 1.00 | 1.00 | 1.00 |

An informal sensory panel with eight untrained panelists sampled the plant-based burgers and rated the samples for overall liking, texture, and preference. Observations are summarized in Tables 6-9.

TABLE 6

| Attribute¹ | Recipe A | Recipe B | Recipe F | Recipe G |
|---|---|---|---|---|
| Appearance liking | 5.5 | 6.0 | 4.0 | 3.5 |
| Taste liking | 5.0 | 6.0 | 4.5 | 5.0 |
| Texture liking | 5.0 | 6.0 | 4.5 | 4.0 |
| Overall liking | 5.0 | 6.0 | 5.0 | 4.0 |

¹1 = “Dislike Extremely”; 2 = “Dislike Moderately”; 3 = “Dislike Slightly”; 4 = “Neither Like nor Dislike”; 5 = “Like Slightly”; 6 = “Like Moderately”; 7 = “Like Extremely”

TABLE 7

| Texture Attribute | Recipe A | Recipe B | Recipe F | Recipe G |
|---|---|---|---|---|
| Hardnes² | 4.0 | 3.0 | 2.0 | 3.0 |
| Juiciness³ | 3.0 | 3.0 | 3.0 | 3.0 |
| Chewiness⁴ | 3.0 | 3.0 | 3.5 | 3.0 |

²1 = “Much Too Soft”; 2 = “Moderately Too Soft”; 3 = “Neither Too Soft nor Too Hard”; 4 = “Moderately Too Hard”; 5 = “Much Too Hard”
³1 = “Much Too Dry”; 2 = “Moderately Too Dry”; 3 = “Neither Too Dry nor Too Juicy”; 4 = “Moderately Too Juicy”; 5 = “Much Too Juicy”
⁴1 = “Not Chewy Enough”; 2 = “Moderately Not Chewy Enough”; 3 = “Neither Not Chewy Enough nor Too Chewy”; 4 = “Moderately Too Chewy”; 5 = “Much Too Chewy”

TABLE 8

| Preference Ranking | Recipe A | Recipe B | Recipe F | Recipe G |
|---|---|---|---|---|
| Most Preferred | 12.5% | 75% | 0% | 12.5% |
| More Preferred | 25% | 12.5% | 50% | 12.5% |
| Less Preferred | 25% | 12.5% | 37.5% | 25% |
| Least Preferred | 37.5% | 0% | 12.5% | 50% |

TABLE 9

| Remarks | Recipe A | Recipe B | Recipe F | Recipe G |
|---|---|---|---|---|
| Visual | Very nice | Nice | Too pinkish | Too red in |
| | appearance | appearance | | the middle, |
| | Maybe too | More shiny/ | | looks like |
| | dry? | glossy on | | not fully |
| | | surface | | cooked, |
| | | | | Not |
| | | | | attractive |
| | | | | color |
| Texture | The firmest | The closest to | Harder pieces, | Lack of bite |
| | texture | meat burger | more chewy | A bit |
| | | Firm bite, | | crumbly |
| | | juicy, ground | | |
| | | meat structure | | |
| Taste | Not balanced | Balanced taste | Not balanced | Not balanced |
| | taste | Too neutral | flavor, | taste |
| | Dominant | taste | cereal taste, | |
| | taste with | No off taste | stronger | |
| | sharp | | aftertaste | |
| | aftertaste | | | |

1. A meat substitute composition, comprising, based on a total weight of the meat substitute composition:
a. 10 to 30 wt % textured plant protein that comprises
i. pea protein; and
ii. wheat gluten;
b. 3 to 15 wt % plant protein powder; and
c. 2 to 8 wt % binding system;
wherein pea protein and wheat gluten in the textured combination are in a ratio 1:0.5 to 1:1.5.

2. The meat substitute composition of claim 1, wherein the plant protein powder comprises:
a. a pea protein; and
b. a wheat gluten;
wherein the pea protein and the gluten are in a ratio of 1:0.4 to 1:1.

3. The meat substitute composition of claim 1, wherein the binding system comprises:
a. a carrageenan;
b. a starch;
c. a plant-based fiber; and
d. a methylcellulose.

4. The meat substitute composition of claim 1, wherein the binding system comprises, based on a total weight of the binding system:
a. 15 to 45 wt % carrageenan;
b. 10 to 40 wt % starch;
c. 1 to 10 wt % plant-based fiber; and
d. 25 to 55 wt % methylcellulose.

5. The meat substitute composition of claim 1, comprising one or more of the following:
a. fat(s) and/or oil(s);
b. salt;
c. water; and
d. optionally a coloring agent, a flavoring agent, and/or a shelf life extender.

6. The meat substitute composition of claim 1, comprising, based on a total weight of the meat substitute composition:
a. 10 to 30 wt % textured plant protein;
b. 3 to 15 wt % plant protein powder;
c. 2 to 8 wt % binding system;
d. 5 to 20 wt % fat(s) and/or oil(s);
e. 0.1 to 1.5 wt % salt;
f. 40 to 70 wt % water;
g. 0.01 to 5 wt % coloring agent;
h. 0.01 to 5 wt % flavoring agent; and
i. 0.01 to 10 wt % shelf life extender.

7. A meat substitute product comprising the meat substitute composition of claim 1.

8. The meat substitute product of claim 7, wherein the meat substitute product is selected from a group consisting of vegetarian or vegan alternatives of burgers, meatballs, minced meat, sausages, nuggets, crumbles, seafood, poultry, breakfast meat, and pet food.

9. Use of a meat substitute composition of claim 1 to make a meat substitute product.

10. A method of making a meat substitute product, comprising the steps of:
a. dispersing one or more of the following in water to form a hydrate:
i. one or more coloring agent(s);
ii. one or more flavoring agent(s); and
iii. one or more shelf life extender(s);
b. mixing the hydrate from step (a) with a textured plant protein and a plant protein powder to form a mixture;
c. mixing the mixture from step (b) with a binding system and one or more of the following to obtain the meat substitute product dough:
i. fat(s) and/or oil(s);
ii. salt;
iii. water; and
iv. optionally any additional coloring agent, flavoring agent, and/or shelf life extender; and
d. cooling and shaping the meat substitute product dough to form the meat substitute product.

11. The method of claim 10, wherein pea protein and wheat gluten in the textured plant protein are in a ratio 1:0.5 to 1:1.5.

12. The method of claim 10, wherein the meat substitute product comprises the meat substitute composition of claim 1.
